(19) United States
(12) Patent Application Publication
(10) Pub. No.: US 2026/0247031 A1
(43) Pub. Date: Aug. 20, 2026

(54) IMAGING DEVICE AND ACCESSORY

(71) Applicant: NIKON CORPORATION, Tokyo (JP)

(72) Inventors: Koji OZAKI, Yokohama-shi (JP); Yasuharu SUGITA, Yokohama-shi (JP); Yoshihiro MATSUMOTO, Kawasaki-shi (JP); Kazuya NISHIO, Kawasaki-shi (JP); Kazuhiro YOSHIKE, Yokohama-shi (JP); Tomoyuki KOHRIYAMA, Tokyo (JP); Kaoru YOSHINO, Tokyo (JP); Mitsuko MATSUMURA, Sagamihara-shi (JP)

(73) Assignee: NIKON CORPORATION, Tokyo (JP)

(21) Appl. No.: 19/471,928

(22) PCT Filed: Mar. 8, 2024
(86) PCT No.: PCT/JP2024/009053

§ 371 Date: Oct. 2, 2025

(30) Foreign Application Priority Data
Apr. 6, 2023 (JP) 2023-062208

(51) Int. Cl. H04N 23/60; H04N 23/53; H04N 23/63

(52) U.S. Cl. CPC H04N 23/665; H04N 23/531; H04N 23/632

(57) ABSTRACT

An imaging device is an imaging device to which an accessory having first electrical contacts can be detachably attached, and includes second electrical contacts that are to be in contact with the first electrical contacts, respectively, and a control unit that controls transmission and reception of data to and from the accessory, wherein the second electrical contacts include third electrical contacts for transmitting and receiving data to and from the accessory in accordance with a first communication method, and the control unit transmits and receives data to and from the accessory in accordance with the first communication method via the third electrical contacts when the accessory is a predetermined accessory, and transmits and receives data to and from the accessory in accordance with a second communication method via at least some of the third electrical contacts when the accessory is an accessory other than the predetermined accessory.

### CROSS-REFERENCE TO RELATED APPLICATION

This application is a national stage application of the prior International Patent Application No. PCT/JP2024/009053, filed on Mar. 8, 2024, which is based upon and claims the benefit of priority of the prior Japanese Patent Application No. 2023-062208, filed on Apr. 6, 2023, the entire contents of which are incorporated herein by reference.

### FIELD

The present disclosure relates to an imaging device and an accessory.

### BACKGROUND

An imaging device including an accessory shoe to which a camera accessory such as a flash device is detachably attached is known (for example, Patent Literature 1).

### CITATION LIST

### Patent Literature

PTL 1: Japanese Patent Application Laid-Open No. 2008-180914

### SUMMARY

According to a first aspect, an imaging device is an imaging device to which an accessory having a plurality of first electrical contacts can be detachably attached, and includes a plurality of second electrical contacts that are to be in contact with the plurality of first electrical contacts, respectively; and a control unit configured to control transmission and reception of data to and from the accessory, wherein the plurality of second electrical contacts include a plurality of third electrical contacts for transmitting and receiving data to and from the accessory in accordance with a first communication method, and the control unit is configured to transmit and receive data to and from the accessory in accordance with the first communication method via the plurality of third electrical contacts when the accessory is a predetermined accessory, and transmits and receives data to and from the accessory in accordance with a second communication method via at least some of the plurality of third electrical contacts when the accessory is an accessory other than the predetermined accessory.

According to a second aspect, an accessory is an accessory attachable to and detachable from an imaging device including a plurality of second electrical contacts, and includes a plurality of first electrical contacts that are to be in contact with the plurality of second electrical contacts, respectively; and a control unit configured to control transmission and reception of data to and from the imaging device, wherein, when the accessory is attached to the imaging device, the control unit transmits information for identifying a communication method with the imaging unit, and then starts communication with the imaging device.

The configuration of the embodiments described later may be appropriately modified, and at least a part thereof may be replaced with another configuration. Furthermore, the constituent elements whose arrangement is not particularly limited are not limited to the arrangement disclosed in the embodiment, and can be arranged at positions where the functions thereof can be achieved.

### BRIEF DESCRIPTION OF THE DRAWINGS

FIG. 1 is a perspective view illustrating a camera according to an embodiment.

FIG. 2 is a perspective view illustrating the camera according to the embodiment.

FIG. 3A is a view of an accessory shoe as viewed from the +Z direction, FIG. 3B is a plan view of the accessory shoe as viewed from the +Y direction, FIG. 3C is a view of a connector as viewed from the −Z direction, and FIG. 3D is a plan view of the connector as viewed from the −Y direction.

FIG. 4 is a block diagram schematically illustrating a configuration of the camera body and the accessory.

FIG. 5 illustrates a hardware configuration of a body control unit.

FIG. 6 is a flowchart illustrating a process executed by the body control unit.

FIG. 7 is a timing chart for describing a process executed by the body control unit.

FIG. 8 is a timing chart for describing a process executed by the body control unit.

FIG. 9A is a view of an accessory shoe according to a variation as viewed from the +Z direction, and FIG. 9B is a plan view of the accessory shoe according to the variation as viewed from the +Y direction.

### DESCRIPTION OF EMBODIMENTS

Hereinafter, a camera 1 according to an embodiment will be described in detail with reference to the drawings. The shapes of the components and the scales such as the lengths, thicknesses, and the like of the components illustrated in the embodiments are not necessarily identical to those of the actual ones, and some components may be omitted in the drawings for easy understanding.

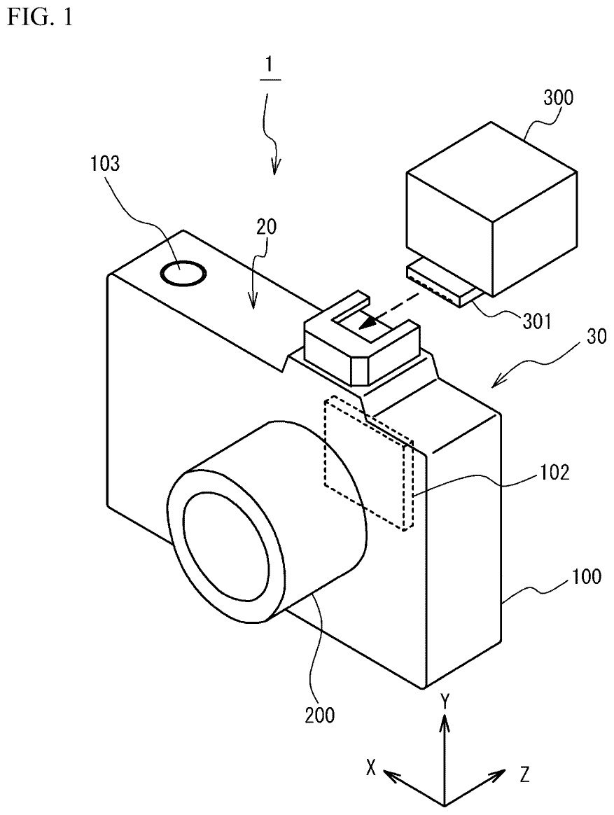

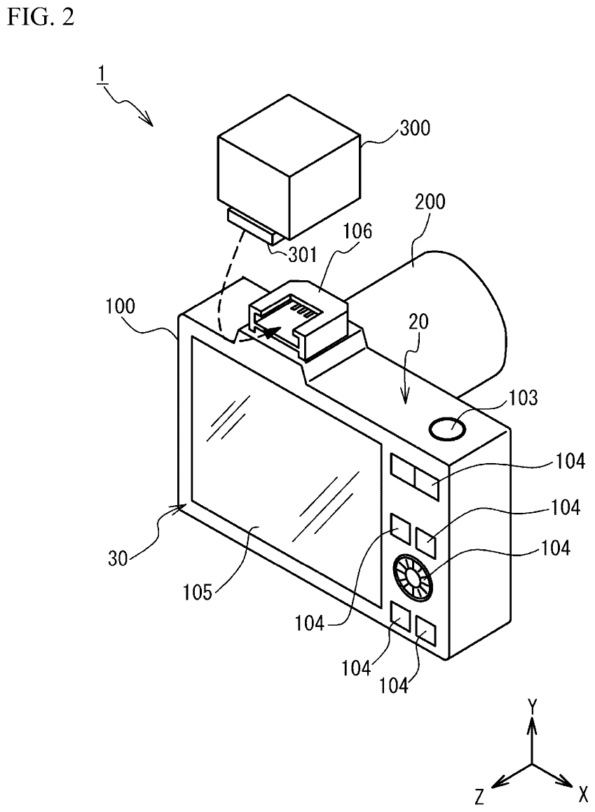

FIG. 1 and FIG. 2 are perspective views illustrating the camera 1 according to the present embodiment. As illustrated in FIG. 1 and FIG. 2, the camera 1 includes a lens barrel 200 and a camera body 100. The lens barrel 200 may be detachable from the camera body 100, or the lens barrel 200 and the camera body 100 may be integrated.

An imaging element 102 such as a CCD (Charge Coupled Device) image sensor or a CMOS (Complementary Metal Oxide Semiconductor) image sensor is provided inside the camera body 100. The imaging element 102 converts a subject image formed by the imaging optical system (lens barrel 200) into an electrical signal.

A release switch 103 is provided on an upper surface 20 of the housing of the camera body 100. Various buttons 104 are provided on a rear surface 30 of the housing of the camera body 100. The user inputs instructions for photographing, instructions for setting photographing conditions, and the like to the camera body 100 using the input devices such as the release switch 103 and the buttons 104.

A rear monitor 105 is provided on the rear surface 30 of the housing of the camera body 100. The rear monitor 105 is a display device using, for example, a liquid crystal display or the like. The rear monitor 105 displays, for example, a live view of a subject image, a menu of photographing settings, and the like.

An accessory shoe 106 to which an accessory 300 is detachably attached is provided on the upper surface 20 of the housing of the camera body 100. The accessory shoe 106 includes a shoe seat 106a and a holding portion 106b.

The accessory 300 includes a connector 301. The accessory 300 can be detachably attached to the camera body 100 by inserting and removing the connector 301 into and from the accessory shoe 106.

The accessory 300 may be, for example, an accessory that provides an electronic viewfinder (EVF) function, a flash device that emits imaging auxiliary light to a subject, a LED (Light Emitting Diode) light, a tally lamp, a microphone, a global positioning system (GPS) receiver, an auxiliary imaging device, or a device that combines any of these.

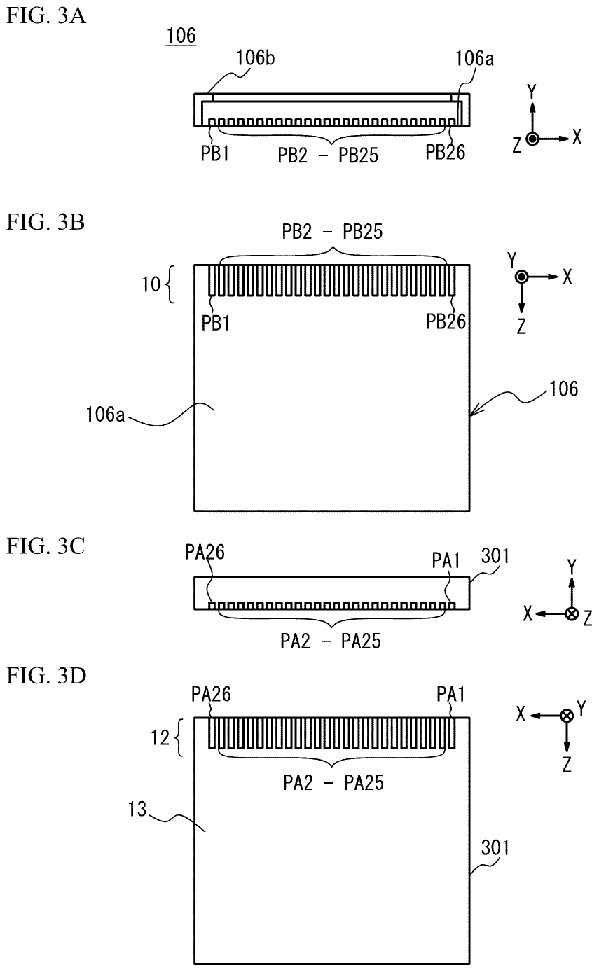

FIG. 3A is a view of the accessory shoe 106 as viewed from the +Z direction, FIG. 3B is a plan view of the accessory shoe 106 as viewed from the +Y direction, FIG. 3C is a view of the connector 301 as viewed from the −Z direction, and FIG. 3D is a plan view of the connector 301 as viewed from the −Y direction. In FIG. 3B, the holding portion 106b is not illustrated.

As illustrated in FIG. 3B, in an end 10 of the shoe seat 106a of the accessory shoe 106, 26 electrical contacts PB1 to PB26 are arranged in a single row in the X direction along the end 10.

As illustrated in FIG. 3C and FIG. 3D, on a lower surface 13 of the connector 301, 26 electrical contacts PA1 to PA26 are arranged in a row in the X direction along an end 12 of the lower surface 13. When the connector 301 is inserted into the accessory shoe 106, a part of the connector 301 is held by the holding portion 106b of the accessory shoe 106, and the connector 301 is fixed to the accessory shoe 106. The phrase “the accessory 300 is attached to the camera body 100” means that the connector 301 is inserted into and fixed to the accessory shoe 106.

When the accessory 300 is attached to the camera body 100, the 26 electrical contacts PA1 to PA26 provided on the lower surface 13 of the connector 301 are physically in contact with the 26 electrical contacts PB1 to PB26 provided on the shoe seat 106a of the accessory shoe 106, respectively. As a result, the 26 electrical contacts PA1 to PA26 and the 26 electrical contacts PB1 to PB26 are electrically connected, respectively. In the present embodiment, the camera body 100 and the accessory 300 each have 26 electrical contacts, but this does not intend to suggest any limitation, and the number of electrical contacts may be 25 or less, or 27 or more.

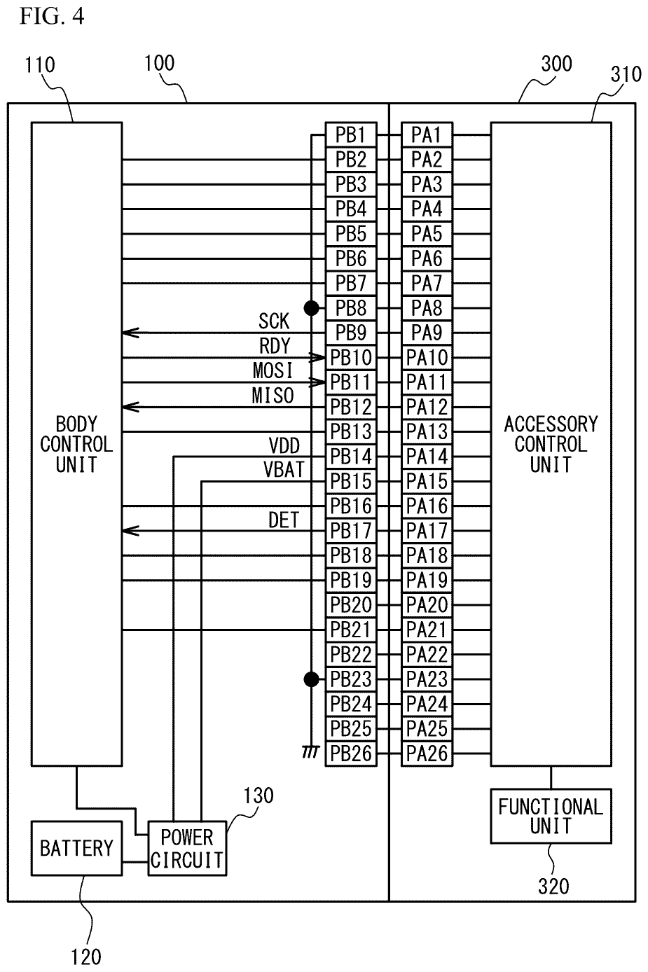

FIG. 4 is a block diagram schematically illustrating the configurations of the camera body 100 and the accessory 300. The camera body 100 includes a body control unit 110.

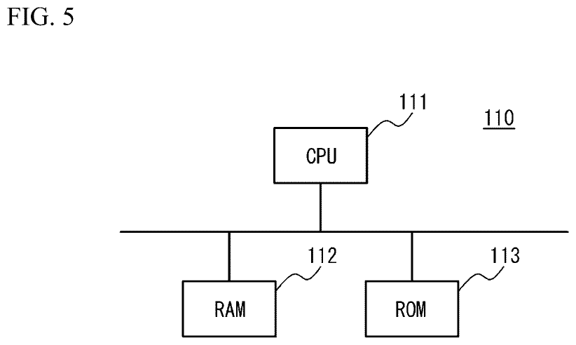

FIG. 5 illustrates a hardware configuration of the body control unit 110. As illustrated in FIG. 5, the body control unit 110 includes a CPU (Central Processing Unit) 111, a RAM (Random-Access Memory) 112, a ROM (Read-Only Memory) 113, and the like.

The ROM (Read-Only Memory) 113 stores, for example, a program for controlling the entire camera body 100, a program for controlling data transmission and reception to and from the accessory 300, and the like. The RAM 112 stores temporary data and the like.

The body control unit 110 controls the entire camera body 100 by reading and executing a control program stored in advance in the ROM 113. The body control unit 110 reads and executes a program for controlling transmission and reception of data to and from the accessory 300 stored in the ROM 113, thereby controlling transmission and reception of data to and from the accessory 300.

Referring back to FIG. 4, in the present embodiment, the 26 electrical contacts PB1 to PB26 provided in the accessory shoe 106 include one electrical contact to which a signal for detecting attachment/detachment of the accessory 300 to/from the accessory shoe 106 is connected, four electrical contacts to which signals for SPI (Serial Peripheral Interface) communication are connected, and two electrical contacts for supplying power to the accessory 300.

In the present embodiment, the electrical contact PB17 is an electrical contact to which the signal DET for detecting attachment/detachment of the accessory 300 to/from the accessory shoe 106 is connected. Further, four electrical contacts to which signals used in the SPI (Serial Peripheral Interface) communication are connected are the electrical contacts PB9, PB10, PB11, and PB12. More specifically, a clock signal SCK for the SPI communication is connected to the electrical contact PB9, a ready signal RDY for the SPI communication is connected to the electrical contact PB10, a signal MOSI transmitted from the camera 1 to the accessory 300 is connected to the electrical contact PB11, and a signal MISO transmitted from the accessory 300 to the camera is connected to the electrical contact PB12.

Further, two electrical contacts for supplying the electric power to the accessory 300 are the electrical contacts PB14 and PB15. The voltage VDD and the voltage VBAT are supplied to the electrical contacts PB14 and PB15, respectively, from a power circuit 130 connected to a battery 120 based on the control from the body control unit 110. The electrical contact PB14 supplies power for controlling the accessory 300 at a lower voltage than the electrical contact PB15. The electrical contact PB15 supplies power necessary for the accessory 300 to function, and the voltage VBAT is higher than the voltage VDD and varies in voltage value depending on the function of the accessory 300.

The following functions are assigned to other electrical contacts, for example. The electrical contacts PB2 to PB7 are contacts for transmitting video data signals to the accessory 300. The electrical contact PB13 is a contact for transmitting a strobe signal. The electrical contacts PB16 to PB19 are contacts used for exchanging a release signal, an insertion/removal detection signal, a half-press signal, and a multifunction signal, respectively. The electrical contacts PB24 to PB26 are contacts for transmitting sound data signals to the accessory 300. The electrical contacts PB1, PB8, and PB23 are grounded, and the electrical contacts PB20 to PB22 are idle terminals (spare terminals).

Note that which signal is connected to which electrical contact is not limited to the present embodiment, and can be set freely.

The accessory 300 includes an accessory control unit 310 and a functional unit 320. The functional unit 320 is a component for exhibiting the function of the accessory 300, and when the accessory 300 is an EVF, the functional unit 320 is a display device, when the accessory 300 is a GPS receiver, the functional unit 320 is a GPS module, and when the accessory 300 is a flash device, the functional unit 320 is a light emitting device.

The accessory control unit 310 includes a CPU, a RAM, a ROM, and the like, and controls the entire accessory 300 and the functional unit 320 based on data transmission and reception with the body control unit 110.

Next, a process executed by the body control unit 110 will be described.

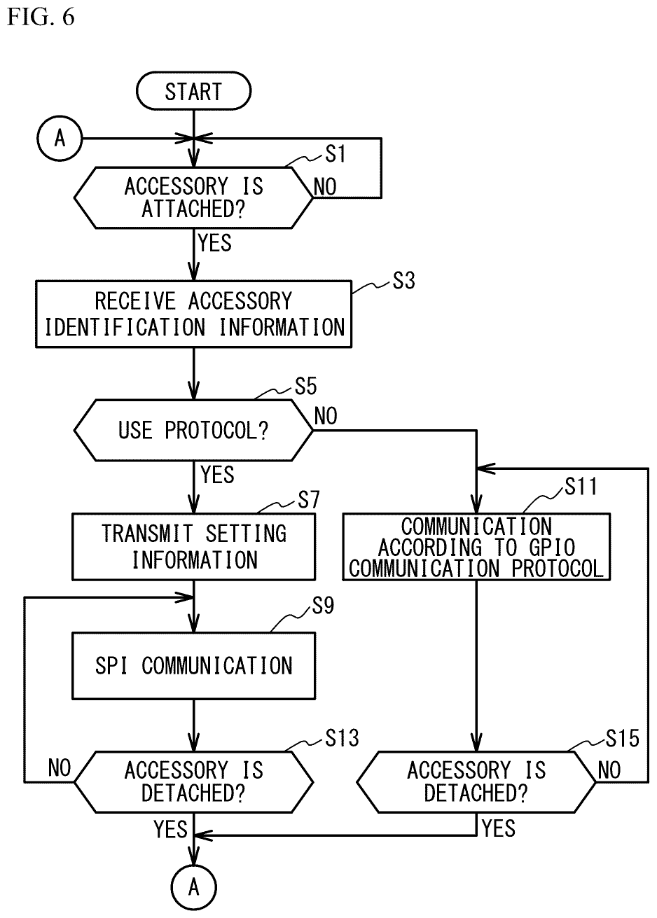

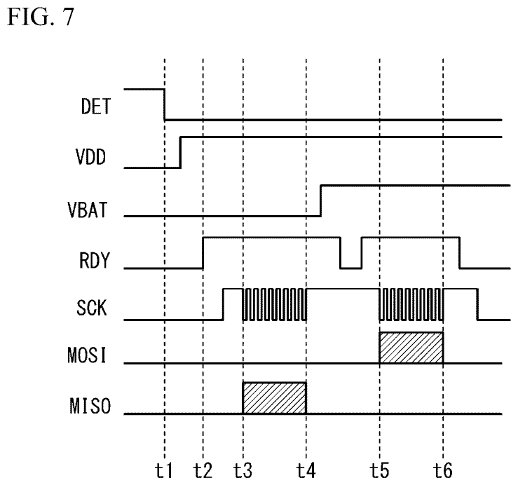

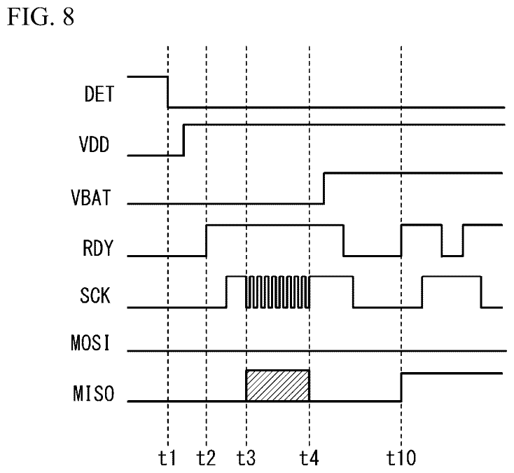

FIG. 6 is a flowchart illustrating the process executed by the body control unit 110. The process illustrated in FIG. 6 is executed when the power of the camera 1 is turned on. The process of FIG. 6 will be described below with reference to the timing charts in FIG. 7 and FIG. 8.

In the process of FIG. 6, the body control unit 110 determines whether the accessory 300 is attached to the accessory shoe 106 (camera body 100) (step S1). In detail, the body control unit 110 determines whether or not the accessory 300 is attached to the accessory shoe 106 based on the signal DET input from the electrical contact PB17. For example, when the signal DET is HIGH in FIG. 7, the body control unit 110 determines that the accessory 300 is not attached to the accessory shoe 106.

When the accessory 300 is not attached to the accessory shoe 106 (step S1/NO), the body control unit 110 repeats step S1 until the accessory 300 is attached to the accessory shoe 106.

When the accessory 300 is attached to the accessory shoe 106 (step S1/YES), the body control unit 110 receives information for identifying the accessory 300 from the accessory 300 (step S3). For example, in FIG. 7, when the signal DET changes from HIGH to LOW at time t1, the body control unit 110 determines that the accessory 300 is attached to the accessory shoe 106. Thereafter, the body control unit 110 starts supplying the voltage VDD to the accessory 300 via the electrical contact PB14.

When the voltage VDD is supplied from the camera 1 and the operation becomes possible, the accessory control unit 310 changes the ready signal RDY from LOW to HIGH. When the ready signal RDY input from the accessory 300 via the electrical contact PA10 (RDY contact) and the electrical contact PB10 changes from LOW to HIGH at time t2, the body control unit 110 starts supplying the clock signal SCK to the accessory 300 within a predetermined time. The period and frequency of the clock signal SCK between time t3 and time t4 are predetermined values. The accessory control unit 310 of the accessory 300 sends the information for identifying the accessory 300 to the body control unit 110 in synchronization with the clock signal SCK input from the camera 1 after changing the ready signal RDY from LOW to HIGH. In FIG. 7, the accessory control unit 310 transmits information for identifying the accessory 300 to the body control unit 110 by the signal MISO during the period from time t3 to time t4. The body control unit 110 receives information for identifying the accessory 300 from the accessory 300 via the electrical contact PB12.

The information for identifying the accessory 300 is, for example, 1-byte data including information about the type of the accessory 300. The information about the type of the accessory 300 may be, for example, the type of the accessory (EVF, microphone, or the like), or the model number or name of the accessory.

Referring back to FIG. 6, the body control unit 110 determines whether or not to use a communication protocol for communication between the camera 1 and the accessory 300 (whether or not a communication protocol exists) based on the information for identifying the accessory 300 received from the accessory 300 (step S5). Specifically, the body control unit 110 determines whether or not to perform the SPI communication with the accessory 300. Here, a table in which information for identifying the accessory 300 and whether or not the accessory 300 uses the communication protocol are associated with each other is stored in the ROM 113 in advance. The body control unit 110 can determine whether or not to use the communication protocol for the communication between the camera 1 and the accessory 300 based on the table. The table may be stored in another nonvolatile storage unit (a flash memory, a hard disk drive, a solid state drive, or the like) instead of the ROM 113. After transmitting the signal MISO, the accessory 300 temporarily sets the ready signal RDY to LOW. After receiving the signal MISO, the camera 1 starts supplying the voltage VBAT according to the accessory 300. After it is determined whether or not to use the communication protocol, the SPI communication or the GPIO communication, which will be described later, is performed.

When the communication protocol is used for the communication with the accessory 300 (step S 5/YES), the body control unit 110 transmits setting information for performing communication by the SPI communication method to the accessory 300 (step S7). For example, in FIG. 7, the body control unit 110 transmits the setting information to the accessory 300 via the electrical contact PB11 during the period from time t5 to time t6. The setting information may include the period, the frequency, and the like of the clock signal used in the SPI communication. The period and frequency of the clock signal used in the SPI communication may be different from those during the period from time t3 to time t4.

Referring back to FIG. 6, the body control unit 110 then performs the SPI communication with the accessory 300 using the electrical contacts PB9 to PB12 (step S9). That is, in FIG. 7, after time t6, the body control unit 110 performs the SPI communication with the accessory 300 using the electrical contacts PB9 to PB12 as necessary. The SPI communication enables, for example, upgrading of the firmware of the accessory 300, transmission of a power information command, sleep control of the accessory 300 from the camera 1, sleep control of the camera 1 from the accessory 300, power control, and notification of the content of an abnormality occurring in the accessory 300 to the camera 1.

On the other hand, when the communication protocol is not used for the communication with the accessory 300 (step S 5/NO), the body control unit 110 performs communication based on the GPIO communication protocol with the accessory 300 using the electrical contacts PB9 to PB12 (step S11). For example, in FIG. 8, when it is determined that the communication protocol is not used for the communication with the accessory 300 based on the information for identifying the accessory 300 received from the accessory 300 during the period from time t3 to time t4, the body control unit 110 uses each of the electrical contact PB9 to PB12 for the transmission or reception of 2-bit data from time t10. In the present embodiment, all of the four electrical contacts PB9 to PB12 are used in communication based on the GPIO communication protocol, but depending on the accessory, communication may be performed using only some of the electrical contacts, without using all of the four electrical contacts PB9 to PB12.

The body control unit 110 continues the process of step S9 or step S11 until the accessory 300 is detached from the accessory shoe 106 (step S 13/NO, step S15/NO). Whether or not the accessory 300 has been detached may be determined using the signal DET or an operation (such as turning off the power) on the camera 1.

When the accessory 300 is detached from the accessory shoe 106 (step S13/YES, step S15/YES), the process returns to step S1, and the processes from step S1 are executed.

As described above in detail, according to the present embodiment, the camera 1 to which the accessory 300 having a plurality of the electrical contacts PA1 to PA26 can be detachably attached includes a plurality of the electrical contacts PA1 to PA26 that come into contact with the plurality of the electrical contacts PB1 to PB26, respectively, and the body control unit 110 that controls transmission and reception of data to and from the accessory 300. The electrical contacts PB1 to PB26 include a plurality of the electrical contacts PB9 to PB12 for transmitting and receiving data to and from the accessory 300 in accordance with the SPI communication method, and the body control unit 110 transmits and receives data to and from the accessory 300 in accordance with the SPI communication method via the electrical contacts PB9 to PB12 when the accessory 300 is an accessory that has a communication protocol between the camera 1 and the accessory 300, and transmits and receives data to and from the accessory 300 in accordance with the GPIO communication scheme via at least some of the electrical contacts when the accessory 300 is not an accessory for which no communication protocol exists between the camera 1 and the accessory 300.

Among the accessories that can be attached to the camera 1, there are accessories that do not support the SPI communication. To cause existing accessories that do not support the SPI communication to support the SPI communication, significant change of the firmware of the accessory is required. It is therefore desirable to be able to control the accessory using a method that is as simple as possible. In the present embodiment, first, it is determined whether the accessory 300 attached to the accessory shoe 106 is an accessory that supports the SPI communication, and when the accessory does not support the SPI communication, at least some of the electrical contacts PB9 to PB12 provided for the SPI communication are used to transmit and receive data in accordance with the GPIO communication protocol. Therefore, even when the accessory 300 that does not support the SPI communication is attached to the camera 1, the accessory 300 can be controlled by signals based on the GPIO communication protocol using at least some of the electrical contacts PB9 to PB12 for the SPI communication. Even in the case of the accessory 300 that does not support the SPI communication, the accessory 300 can be controlled from the camera 1 by performing communication based on the GPIO communication protocol.

In the above embodiment, the case where the information for identifying the accessory 300 and whether or not to use the communication protocol are stored in the ROM 113 in association with each other has been described, but only the identification information of the accessory 300 that uses the communication protocol may be stored in the ROM 113. That is, when the accessory 300 is a predetermined accessory stored in the ROM 113, the body control unit 110 determines that the communication protocol is to be used and performs the SPI communication, and when the accessory 300 is an accessory other than the predetermined accessory stored in the ROM 113, the body control unit 110 may perform communication according to the GPIO communication protocol. Alternatively, only information for identifying the accessory 300 that does not use the communication protocol may be stored in the ROM 113. That is, the body control unit 110 may determine that the accessory 300 not stored in the ROM 113 uses the communication protocol.

In the above-described embodiment, when there is a communication protocol between the camera 1 and the accessory 300, the SPI communication is performed, but this does not intend to suggest any limitation. For example, in a case that there is a communication protocol between the camera 1 and the accessory 300, bidirectional communication such as I2C (Inter-Integrated Circuit) communication may be performed.

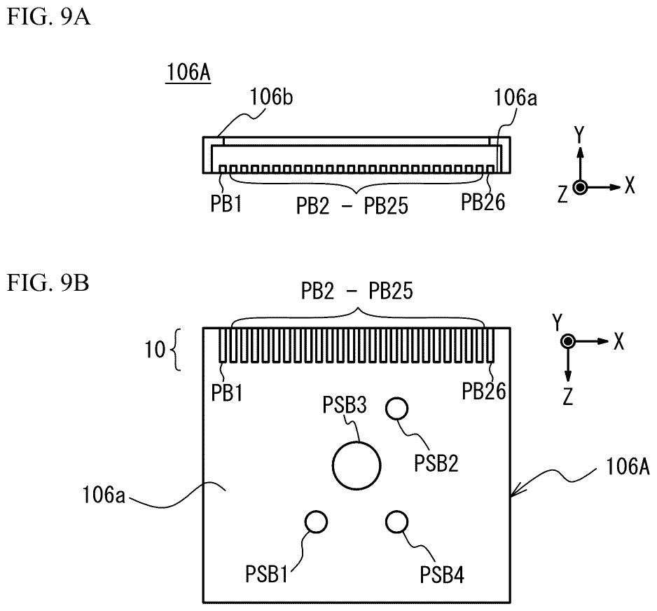

In the above-described embodiment, the accessory shoe 106 includes the electrical contacts PB1 to PB26, but this does not intend to suggest any limitation. FIG. 9A and FIG. 9B are views illustrating an accessory shoe 106A according to a variation. In FIG. 9B, the holding portion 106b is not illustrated.

The accessory shoe 106A has the electrical contacts PB1 to PB26, and the electrical contacts PSB1 to PSB4 in the central portion of the shoe seat 106a. The electrical contacts PSB1 to PSB4 are used when the accessory 300 is, for example, a flash device. In this manner, the accessory shoe 106A may include other electrical contacts in addition to the electrical contacts PB1 to PB26.

The above-described embodiments are preferred examples. However, this does not intend to suggest any limitation, and various modifications can be made without departing from the scope thereof, and arbitrary constituent elements may be combined.

1. An imaging device to which an accessory having a plurality of first electrical contacts can be detachably attached, the imaging device comprising:
a plurality of second electrical contacts that are to be in contact with the plurality of first electrical contacts, respectively; and
a control unit configured to control transmission and reception of data to and from the accessory,
wherein the plurality of second electrical contacts include a plurality of third electrical contacts for transmitting and receiving data to and from the accessory in accordance with a first communication method, and
wherein the control unit is configured to transmit and receive data to and from the accessory in accordance with the first communication method via the plurality of third electrical contacts when the accessory is a predetermined accessory, and transmits and receives data to and from the accessory in accordance with a second communication method via at least some of the plurality of third electrical contacts when the accessory is an accessory other than the predetermined accessory.

2. The imaging device according to claim 1, wherein the predetermined accessory is an accessory that has a communication protocol between the imaging device and the accessory.

3. The imaging device according to claim 1, wherein the control unit is configured to:
obtain information for identifying the accessory from the accessory using at least two of the plurality of third electrical contacts; and
determine whether a communication protocol exists between the imaging device and the accessory based on the information.

4. The imaging device according to claim 1, wherein the control unit is configured to determine whether or not there is a communication protocol between the imaging device and the accessory by referring to a storage unit that stores information for identifying the accessory and whether or not there is a communication protocol between the imaging device and the accessory in association with each other. (Currently Amended) The imaging device according to claim 1,
wherein the first communication method is a SPI (Serial Peripheral Interface) communication method, and
wherein the second communication method is a GPIO (General Purpose Input/Output) communication method.

6. An accessory attachable to and detachable from an imaging device including a plurality of second electrical contacts, the accessory comprising:
a plurality of first electrical contacts that are to be in contact with the plurality of second electrical contacts, respectively; and
a control unit configured to control transmission and reception of data to and from the imaging device,
wherein, when the accessory is attached to the imaging device, the control unit transmits information for identifying a communication method with the imaging unit, and then starts communication with the imaging device.

7. The accessory according to claim 6,
wherein the plurality of first electrical contacts include an RDY contact for transmitting information indicating whether communication with the imaging device is possible to the imaging device,
wherein the control unit is configured to:
when the accessory is attached to the imaging device, change a signal from the RDY contact from LOW to HIGH, and
when transmitting the information for identifying the communication method with the imaging device to the imaging device, change the signal from the RDY contact from HIGH to LOW, and then start communication in the communication method.

8. The accessory according to claim 6,
wherein the communication method is bidirectional communication between the imaging device and the accessory, and
wherein the control unit is configured to transmit the information for identifying the communication method with the imaging device to the imaging device, and then receives setting information of the bidirectional communication from the imaging device.
